(19) United States
(12) Patent Application Publication
(10) Pub. No.: US 2023/0035696 A1
(43) Pub. Date: Feb. 2, 2023

(54) INTELLIGENT BUILDING BLOCK-BASED CHINESE CHARACTER LEARNING SYSTEM

(71) Applicant: Hangzhou Gaodi Technology Co., Ltd., Hangzhou, Zhejiang (CN)

(72) Inventor: Xudong He, Hangzhou, Zhejiang (CN)

(21) Appl. No.: 17/787,444

(22) PCT Filed: Jan. 6, 2020
(86) PCT No.: PCT/CN2020/070420

§ 371 Date: Jun. 20, 2022

(30) Foreign Application Priority Data
Dec. 26, 2019 (CN) 201911372618.X

(51) Int. Cl. G09B 19/06; G06V 30/28

(52) U.S. Cl. CPC G09B 19/06; G06V 30/293

(57) ABSTRACT

An intelligent building block-based Chinese character learning system, relating to the technical field of intelligent building block-based Chinese character learning. Chinese characters are combined freely and conveniently. Moreover, Chinese characters combined by a child are combined with online courses, so that online courses are triggered by means of assembly by the child, and interactive Chinese character teaching is implemented. The system comprises: an instruction module, used for bearing Chinese characters and building block assembly of the Chinese characters; a master control board module, used for reading the Chinese characters assembled by the instruction modules, displaying the assembled Chinese characters, and synchronizing the assembled Chinese characters to a mobile phone or an iPad; and an online course module, used for reading the Chinese characters synchronized by the master control board module and searching for an online course.

### 1. TECHNICAL FIELD

The invention belongs to the technical field of intelligent building block-based Chinese character learning, in particular relates to an intelligent building block-based Chinese character learning system.

### 2. BACKGROUND

With the rapid development of informatization, there are more and more occasions for people to input Chinese characters by typing on the keyboard, which is more and more convenient; in the eyes of the ancients, Chinese characters that are graceful and beautiful, with both form and spirit, have now become the product of the combination of letters on computer keyboards and mobile phone screens. In daily work and life, we use the keyboard to input pinyin to type, and the opportunity to write Chinese characters is decreasing. It is not alarmist that Chinese characters face a crisis.

Chinese characters are the foundation for the excellent traditional Chinese culture to be passed on from generation to generation and continue to flourish. To inherit the excellent traditional Chinese culture, Chinese character education should be regarded as a strategic project to concentrate and build the soul.

Chinese characters are pictographs with three elements: shape, sound and meaning. Chinese characters not only express concepts, connotations, and denotations, but also bring people graphics, associations, and feelings. Compared with pinyin characters, Chinese characters have distinctive features and unique charm. Learning and understanding Chinese characters should follow the rules and characteristics of Chinese characters.

According to the three elements of “shape, sound and meaning” and the characteristics of children's good at “image memory”, the invention explores new concepts and new ways of teaching Chinese characters such as “telling the meaning of the character from the shape” and “classifying and teaching according to the classification”. Through these methods, the cultural genes of each Chinese character are vividly taught to students, so that students are interested in Chinese characters, develop love, understand logic, and think.

The technical problem to be solved by the invention is how to freely and conveniently combine Chinese characters, and at the same time, combine the Chinese characters combined by children with online courses, and trigger online courses by means of assembly by the child, so as to implement interactive Chinese character teaching.

### 3. SUMMARY

The purpose of the invention is to provide an intelligent building block-based Chinese character learning system, to freely and conveniently combine Chinese characters, and at the same time, combine the Chinese characters combined by children with online courses, and trigger online courses by means of assembly by the child, so as to implement interactive Chinese character teaching.

The above technical problem is solved by the following technical solutions: An intelligent building block-based Chinese character learning system, comprising: An instruction module, which is used for bearing Chinese characters and building block assembly of the Chinese characters;

A master control board module, which is used for reading the Chinese characters assembled by the instruction module, displaying the assembled Chinese characters, and synchronizing the assembled Chinese characters to a mobile phone or an iPad;

An online course module, which is used for reading the Chinese characters synchronized by the master control board module and searching for an online course, recognizing the three elements of “shape, sound and meaning” and the development history of the Chinese character through the guidance of the online course, and expanding to the historical stories related to the Chinese character.

The solution facilitates children to freely and conveniently combine Chinese characters, and at the same time, combine the Chinese characters combined by children with online courses, and trigger online courses by means of assembly by the child, so as to implement interactive Chinese character teaching.

Preferably, (2.1) the building blocks of Chinese characters communicate with each other through serial communication, and the Chinese character instructions and the topological relationship between the instructions stored in the EEPROM are sent to the master control board;

(2.2) After the master control board reads the Chinese character instructions and the topological structure, it calculates according to the Chinese character recognition process to form a complete Chinese character, and displays the Chinese character on an ink screen;

(2.3) The master control board synchronizes the instructions and the topological structure to the iPad through Bluetooth, and the iPad also analyzes it, displays the Chinese character, and looks up the ancient Chinese dictionary and corresponding online courses; if the Chinese character does not exist, the user will be prompted that such a combination does not exist; if the corresponding online course is found, the course will be played; if no online course is found, the explanation in the ancient Chinese dictionary will be played.

Preferably, in step (2.1), the building blocks communicate with the outside world through the serial port, and read Chinese character instructions from top to bottom or left to right; CRC check is performed on externally read instructions; read the local Chinese character instruction stored in the EEPROM; combine the topological structure of the external Chinese character instruction with the local Chinese character instruction; send the combined instruction up and left;

In step (2.2), the Chinese character recognition process is as follows: First, the master control board will select the commonly used single characters and create a single character table;

Each building block represents a single character, and a single character instruction library is created with unicode as the hash value, and the unicode of the Chinese character is stored in the EEPROM of the building block;

The master control board will select the commonly used radicals and create a radical table; The radicals are divided into left and right, up and down and semi-enclosed structures according to the size;

A database of commonly used Chinese characters is created based on the method of splitting Chinese characters;

According to the order from top to bottom and from left to right, one thousand commonly used Chinese characters are split into radicals and single characters, and a database composed of unicode is created;

The master control board finds Chinese characters by reading the building block instructions and the topological relationship between them through the serial port;

The master control board displays the Chinese character through the ink screen; If it is a Chinese character phrase, topological analysis is performed in the same way, but ambiguity may occur; at this time, it is necessary to look up the corresponding dictionary according to the Chinese characters to display the possible Chinese character phrase.

The invention can achieve the following effects: The invention facilitates children to freely and conveniently combine Chinese characters, and at the same time, combine the Chinese characters combined by children with online courses, and trigger online courses by means of assembly by the child, so as to implement interactive Chinese character teaching.

### 4. BRIEF DESCRIPTION OF THE FIGURES

FIG. 1 is a schematic block diagram of a system connection according to Embodiment 1.

FIG. 2 is a schematic diagram of a demonstration connection of the building blocks of Embodiment 1 to form the Chinese characters “ [symbol] ” and “ [symbol] ”.

FIG. 3 is a flow chart showing that the building blocks of Chinese characters communicate with each other through serial communication in Embodiment 1, and the Chinese character instructions and the topological relationship between the instructions stored in the EEPROM are sent to the master control board;

FIG. 4 is a flowchart of Chinese character recognition process in Embodiment 1.

FIG. 5 is a schematic diagram of the Chinese character “ [symbol] ” formed by 6 building blocks in Embodiment 1.

FIG. 6 is a block position diagram of the shape after reading the topological relationship of the Chinese character “ [symbol] ” in Embodiment 1.

FIG. 7 is a schematic diagram showing that if it is a Chinese character phrase in Embodiment 1, topological analysis is performed in the same way, but ambiguity may occur.

FIG. 8 is a flow chart of Embodiment 1.

FIG. 9 is a circuit diagram of Embodiment 1.

FIG. 10 is a schematic diagram of a connection structure in which the tangible programming instruction building block A and the tangible programming instruction building block B are connected according to Embodiment 2.

FIG. 11 is a schematic diagram of a demonstration connection in which three storage building blocks can be connected to the basic building blocks in a one-to-one manner according to Embodiment 2.

FIG. 12 is a schematic diagram of the relationship between the hardware cost and the number of instructions according to Embodiment 2.

FIG. 13 is a schematic diagram showing that the basic building block group has three basic building blocks and the storage building block group has two storage building blocks according to Embodiment 2.

FIG. 14 is a schematic diagram of a water surface cross-sectional connection structure in which a storage building block has not been connected to a basic building block according to Embodiment 2.

FIG. 15 is a schematic diagram of a horizontal cross-sectional connection structure when a cylindrical block is also placed in the basic circular semi-through hole on the basic building block according to Embodiment 2.

FIG. 16 is a schematic diagram of a horizontal cross-sectional connection structure at the cylindrical block according to Embodiment 2.

FIG. 17 is a schematic diagram of a vertical cross-sectional connection structure when a cylindrical block has been placed in the basic circular semi-through hole on the basic building block according to Embodiment 2.

FIG. 18 is a schematic diagram of a connection structure at the sliding tube according to Embodiment 2.

FIG. 19 is a schematic diagram of a connection structure of the communication module according to Embodiment 2.

FIG. 20 is a schematic diagram of a connection structure in which the sliding tube is connected to the communication module according to Embodiment 2.

FIG. 21 is a schematic diagram of a connection structure of the butt joint connection mechanism on the cylindrical block according to Embodiment 2.

FIG. 22 is a schematic view of a top-view connection structure when a cylindrical block has not been placed in the basic circular semi-through hole on the basic building block according to Embodiment 2.

FIG. 23 is a schematic view of a top-view connection structure when a cylindrical block has been placed in the basic circular semi-through hole on the basic building block according to Embodiment 2.

FIG. 24 is a schematic diagram of a connection structure in which two storage building blocks are respectively connected to two basic building blocks and one parameter building block is connected to one basic building block according to Embodiment 2.

FIG. 25 is a schematic diagram of a connection structure when the upper surface of the basic building block is provided with an upper surface groove, the lower surface of the storage block is provided with a positioning protrusion, and the positioning protrusion of the storage building block has not been inserted into the upper surface groove of the basic building block according to Embodiment 2.

FIG. 26 is a schematic diagram of a connection structure when the positioning protrusion of the storage building block has been inserted into the groove on the upper surface of the base building block according to Embodiment 2.

### 5. SPECIFIC EMBODIMENT OF THE INVENTION

The invention will be further described hereinafter with reference to the drawings.

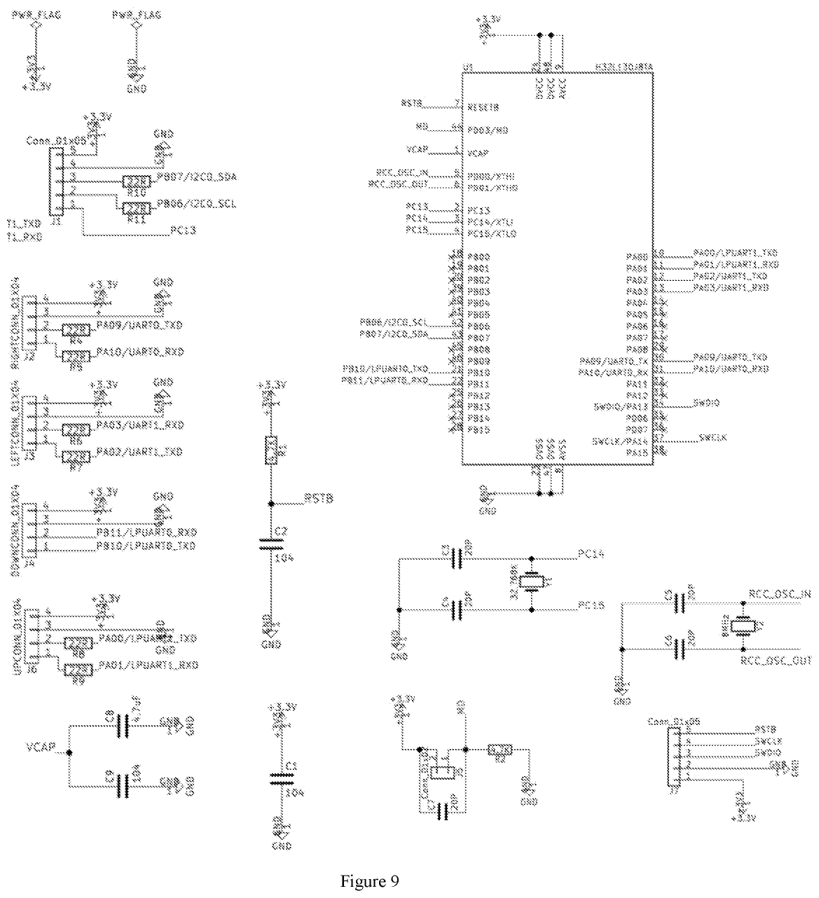

Embodiment: an intelligent building block-based Chinese character learning system, as shown in FIG. 1 and FIG. 9, comprising:

An instruction module, which is used for bearing Chinese characters and building block assembly of the Chinese characters;

A master control board module, which is used for reading the Chinese characters assembled by the instruction module, displaying the assembled Chinese characters, and synchronizing the assembled Chinese characters to a mobile phone or an iPad;

An online course module, which is used for reading the Chinese characters synchronized by the master control board module and searching for an online course, recognizing the three elements of “shape, sound and meaning” and the development history of the Chinese character through the guidance of the online course, and expanding to the historical stories related to the Chinese character.

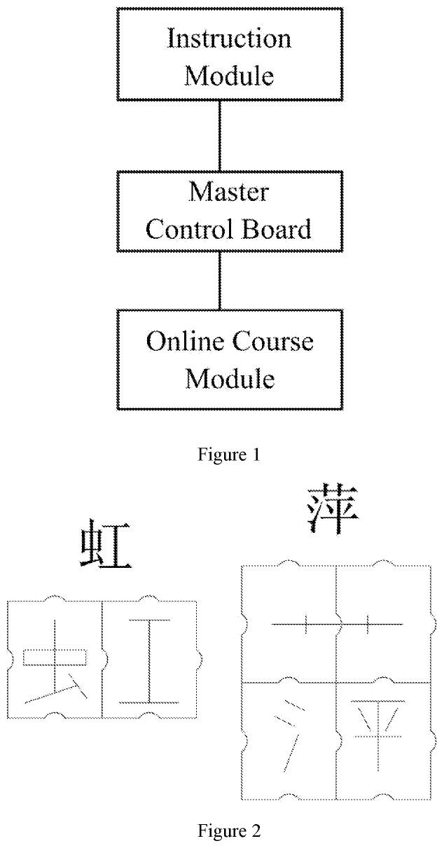

As shown in FIG. 2, the curved part of the building block is a magnetic needle, and the building blocks are adsorbed together through the magnetic needle, up or down, left or right, to form Chinese characters. Chinese characters are mainly based on the left-right structure and the top-bottom structure, and semi-enclosed, top-middle-bottom, left-middle-right, or more complex combinations are also existed.

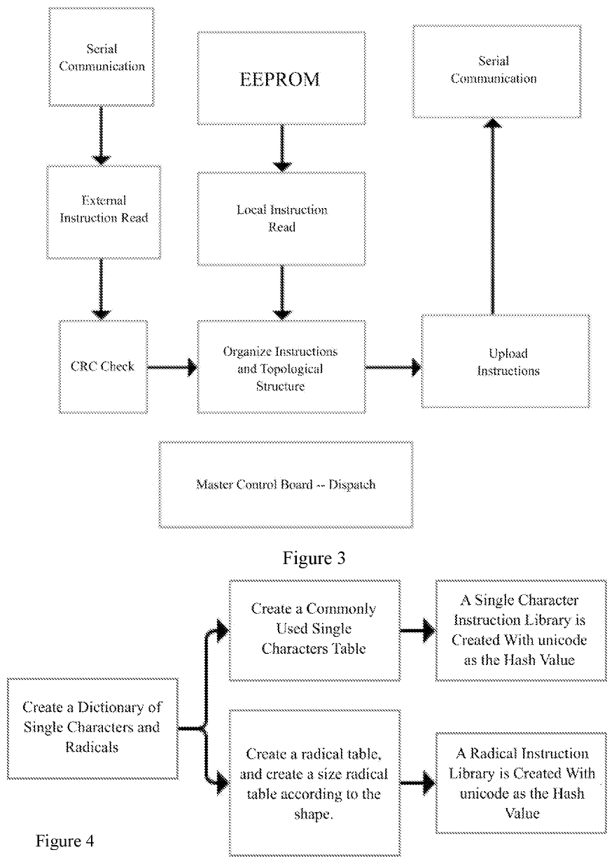

(2.1) The building blocks of Chinese characters communicate with each other through serial communication, and the Chinese character instructions and the topological relationship between the instructions stored in the EEPROM are sent to the master control board; as shown in the flow chart in FIG. 3.

The building blocks communicate with the outside world through the serial port, and read Chinese character instructions from top to bottom or left to right;

CRC check is performed on externally read instructions;

Read the local Chinese character instruction stored in the EEPROM;

Combine the topological structure of the external Chinese character instruction with the local Chinese character instruction;

Send the combined instruction up and left;

(2.2) After the master control board reads the Chinese character instructions and the topological structure, it calculates according to the Chinese character recognition process to form a complete Chinese character, and displays the Chinese character on an ink screen;

Taking “ [symbol] ” as an example: “ [symbol] ” is sent to the left of “ [symbol] ”, “ [symbol] ” reads “ [symbol] ”, and it is recorded as “ [symbol] ” and upward sent to the master control board. The master control board forms the Chinese character “ [symbol] ” through lexical analysis and syntax analysis.

With reference to FIG. 4, the Chinese character recognition process is as follows:

At the same time, the common radicals are established, and a radical table is created according to the shape, and the radical instruction library is established with unicode as the hash value. The upper surface of each building block is provided with a silk-screen pattern corresponding to the radicals.

First, the master control board will select the commonly used single characters and create a single character table;

Each building block represents a single character, and a single character instruction library is created with unicode as the hash value, and the unicode of the Chinese character is stored in the EEPROM of the building block;

For example, the unicode code of the single character “ [symbol] ” is 0x5DE5, and 0x5DE5 is stored in the EEPROM of the building block.

The single characters are shown in Table 1:

TABLE 1
Single Character Table

| Letters | Single Characters |
|---|---|
| A | [symbol] |
| B | [symbol] [symbol] |
| C | [symbol] [symbol] |
| D | [symbol] |
| E | [symbol] |
| F | [symbol] |
| G | [symbol] [symbol] |
| H | [symbol] |
| J | [symbol] [symbol] |
| K | [symbol] |
| L | [symbol] [symbol] |
| M | [symbol] [symbol] |
| N | [symbol] |
| P | [symbol] |
| Q | [symbol] [symbol] |
| R | [symbol] |
| S | [symbol] [symbol] [symbol] |
| T | [symbol] |
| W | [symbol] [symbol] |
| X | [symbol] |
| Y | [symbol] [symbol] [symbol] |
| | [symbol] |
| Z | [symbol] [symbol] |

Then the master control board will select the commonly used radicals and create a radical table;

The radicals are divided into left and right, up and down and semi-enclosed structures according to the size;

Taking “ [symbol] ” as an example: it is composed of either one building block or two left and right building blocks. If it is composed of one building block, it is “ [symbol] ”; if it is composed of two building blocks, the left one is 1 “ [symbol] ”, and the right one is 2 “ [symbol] ”.

Taking “ [symbol] ” as an example: it is composed of either one building block or two upper and lower building blocks. If it is composed of one building block, it is “ [symbol] ”; if it is composed of two building blocks, the upper one is 1 “ [symbol] ”, and the lower one is 2 “ [symbol] ”.

If it is one building block, the EEPROM of the building block stores the unicode code of the radical. For example, the unicode of “ [symbol] ” is 0x8279, and the EEPROM of the building block stores 0x8279. If two building blocks are needed to represent a radical, for example, the left and right building blocks are combined into “ [symbol] ”, the left one is 1 “ [symbol] ”, and the right one is 2 “ [symbol] ”; then the EEPROM value of the left building block is 0x18279, and the EEPROM of the right building block is 0x28279.

The radicals are shown in Table 2:

TABLE 2
Radical Table

| Num- | |
|---|---|
| ber | |
| of | |
| Strokes | Radicals |
| 1 | [symbol] [symbol] |
| 2 | [symbol] [symbol] |
| | [symbol] [symbol] |
| | [symbol] [symbol] |
| 3 | [symbol] [symbol] |
| | [symbol] [symbol] |
| | [symbol] [symbol] |
| | [symbol] [symbol] |
| | [symbol] |
| 4 | [symbol] [symbol] |
| | [symbol] [symbol] |
| | [symbol] [symbol] |
| | [symbol] [symbol] |
| | [symbol] [symbol] |
| | [symbol] |
| 5 | [symbol] [symbol] |
| | [symbol] [symbol] |
| | [symbol] [symbol] |
| 6 | [symbol] [symbol] |
| | [symbol] [symbol] |
| | [symbol] [symbol] |
| 7 | [symbol] [symbol] |
| | [symbol] [symbol] |
| | [symbol] |
| 8 | [symbol] [symbol] |
| | [symbol] |
| 9 | [symbol] [symbol] |
| | [symbol] |
| 10 | [symbol] |
| 11 | [symbol] |
| 12 | [symbol] |
| 13 | [symbol] |
| 14 | [symbol] |
| 15 | [symbol] |

A database of commonly used Chinese characters is created based on the method of splitting Chinese characters;

According to the order from top to bottom and from left to right, one thousand commonly used Chinese characters are split into radicals and single characters, and a database composed of unicode is created;

Taking “ [symbol] ” as an example: it is split into “ [symbol] ” “ [symbol] ” “ [symbol] ” “ [symbol] ”, and their unicode values are: 0x8279, 0x4E2C, 0x5915, 0x5BF8, and these four unicodes form a long integer: 0x82794E2C59155BF8, as the index of “ [symbol] ”.

With reference to the online character splitting tool: https://tool.lu/zhcomponent/index.html. The master control board finds Chinese characters by reading the building block instructions and the topological relationship between them through the serial port;

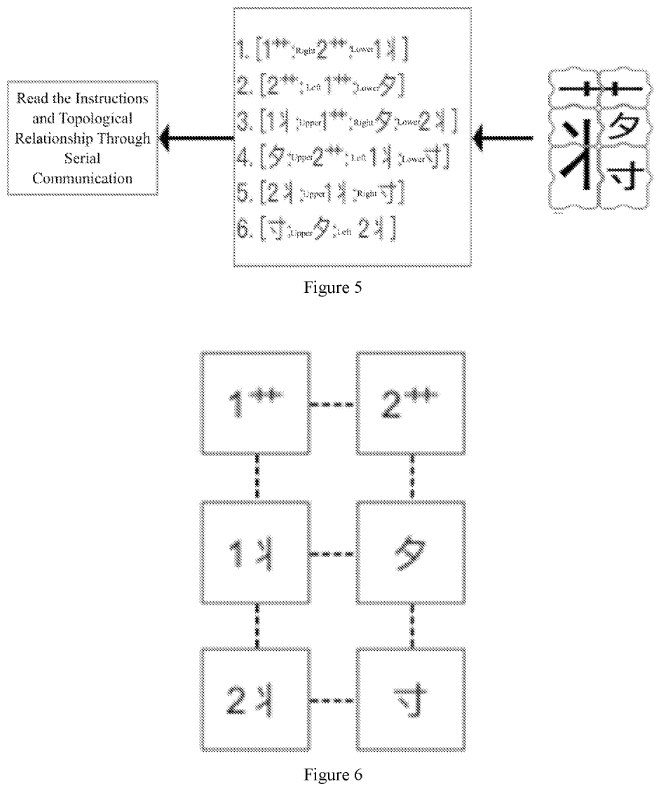

As shown in FIG. 5, 6 building blocks form the Chinese character “ [symbol] ”; each instruction will send and read the value of the adjacent EEPROM from the four directions of up, down, left and right, and then the read instructions are organized in the way of →self: up: left: right: down; if there is no read instruction, then leave it vacant. The organized instructions are sent upward, and the master control board finally obtains all the topology information. (Note: The Chinese characters in the picture should actually be unicode codes; in order to make it easier for readers to understand, they are displayed as Chinese characters).

After the topological relationship of the Chinese character “ [symbol] ” is read, the building block position map shown in FIG. 6 is formed.

Then these unicode codes are combined according to the principle from top to bottom and from left to right to form: 1 “ [symbol] ” 2 “ [symbol] ” 1 “ [symbol] ” “ [symbol] ” 2 “ [symbol] ” “ [symbol] ”, wherein the codes with the same unicode are merged, for example: 1 “ [symbol] ” 2 “ [symbol] ” are merged into “ [symbol] ”, and 1 “ [symbol] ” 2 “ [symbol] ” are merged into “ [symbol] ”, and the final composition is: “ [symbol] ” “ [symbol] ” “ [symbol] ” “ [symbol] ”. Then, according to the index composed of these four unicodes: 0x82794E2C59155BF8, search the database of commonly used Chinese characters stored in the master control board, and the Chinese character “ [symbol] ” can be found.

The master control board displays the Chinese character through the ink screen;

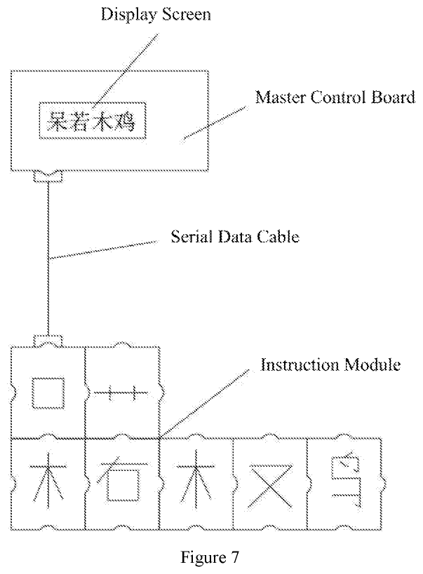

With reference to FIG. 7, if it is a Chinese character phrase, topological analysis is performed in the same way, but ambiguity may occur; at this time, it is necessary to look up the corresponding dictionary according to the Chinese characters to display the possible Chinese character phrase.

As shown in FIG. 7, according to the topological structure, the Chinese characters that may be read are:

[symbol] ;

[symbol] ;

[symbol] .

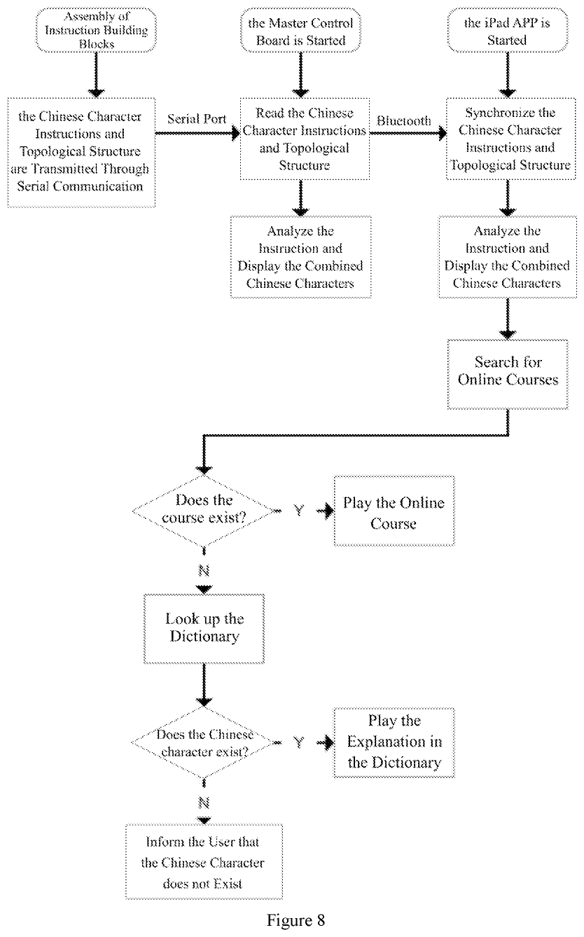

(2.3) With reference to FIG. 8, the master control board synchronizes the instructions and the topological structure to the iPad through Bluetooth, and the iPad also analyzes it, displays the Chinese character, and looks up the ancient Chinese dictionary and corresponding online courses; if the Chinese character does not exist, the user will be prompted that such a combination does not exist; if the corresponding online course is found, the course will be played; if no online course is found, the explanation in the ancient Chinese dictionary will be played.

After the building blocks are assembled, the Chinese character instructions and topological structure are transmitted between the building blocks through serial communication;

After the master control board is started, the master control board reads the Chinese character instructions and topological structure through the serial port, analyzes the instructions and displays the combined Chinese characters;

After the iPad APP is started, the master control board of the iPad synchronizes the Chinese character instructions and topological structure through Bluetooth, analyzes the instructions and displays the combined Chinese characters, and then searches for online courses; if the course exists, play the online course; if the course does not exist, look up the dictionary; if the Chinese character exists, play the explanation in the dictionary; if the Chinese character does not exist, inform the user that the Chinese character does not exist.

The embodiment facilitates children to freely and conveniently combine Chinese characters, and at the same time, combine the Chinese characters combined by children with online courses, and trigger online courses by means of assembly by the child, so as to implement interactive Chinese character teaching.

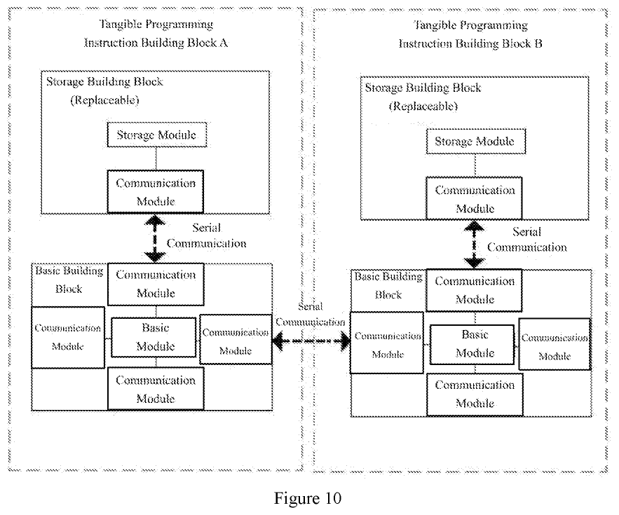

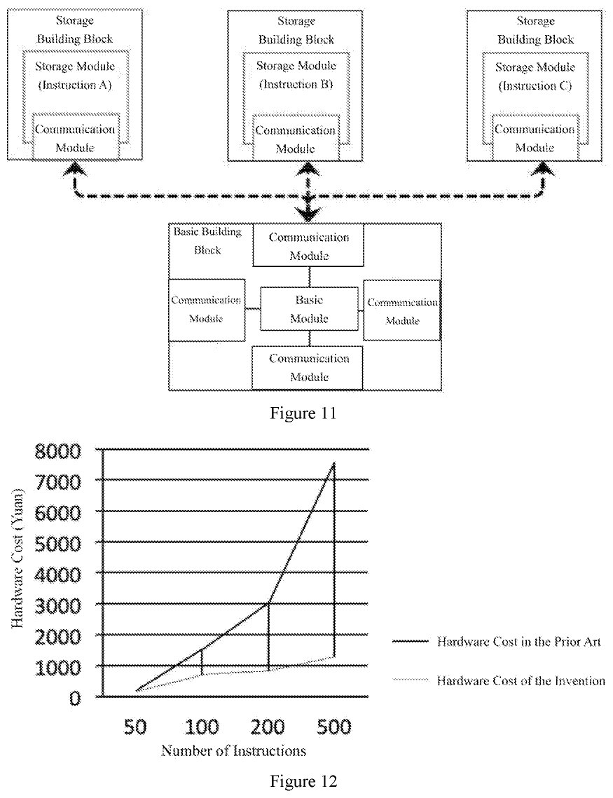

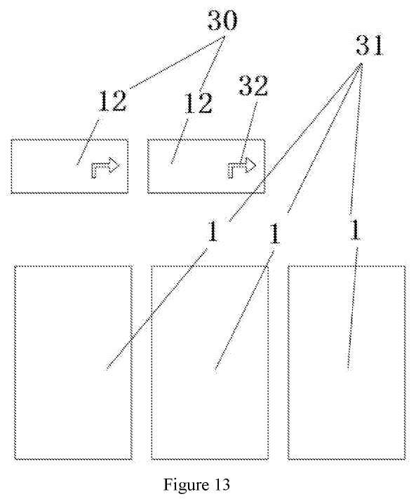

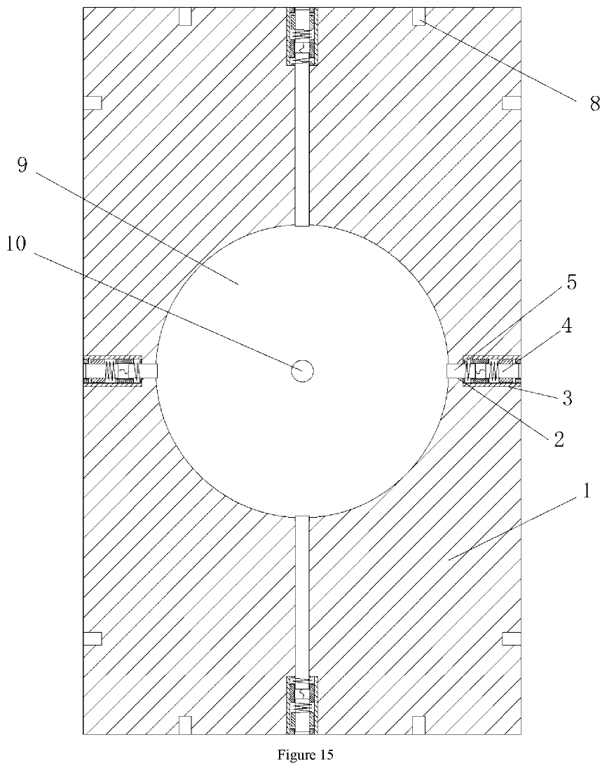

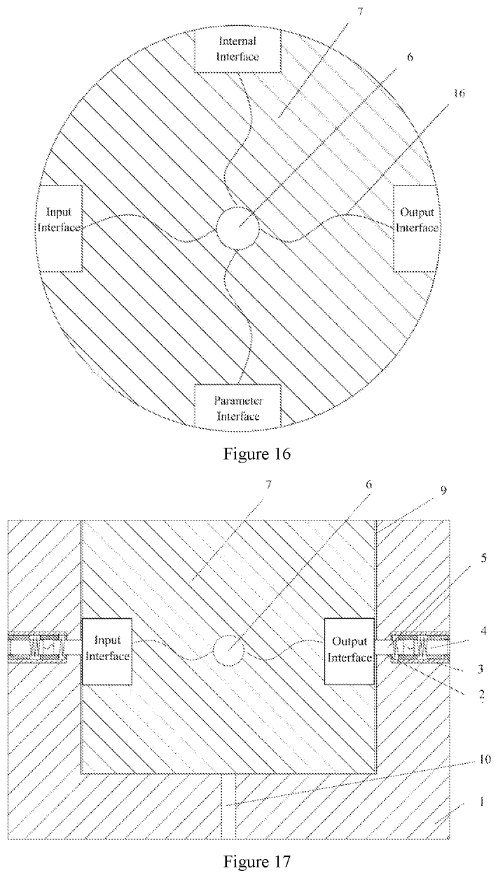

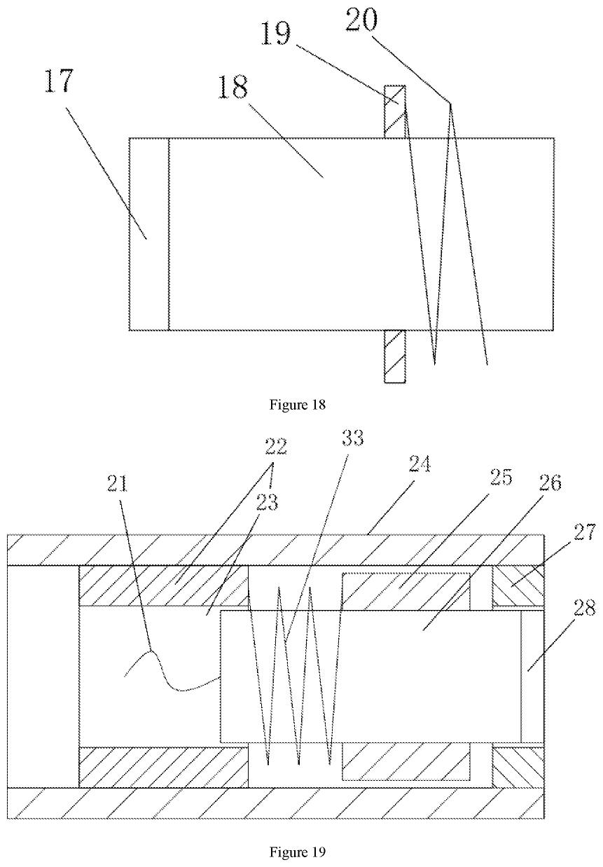

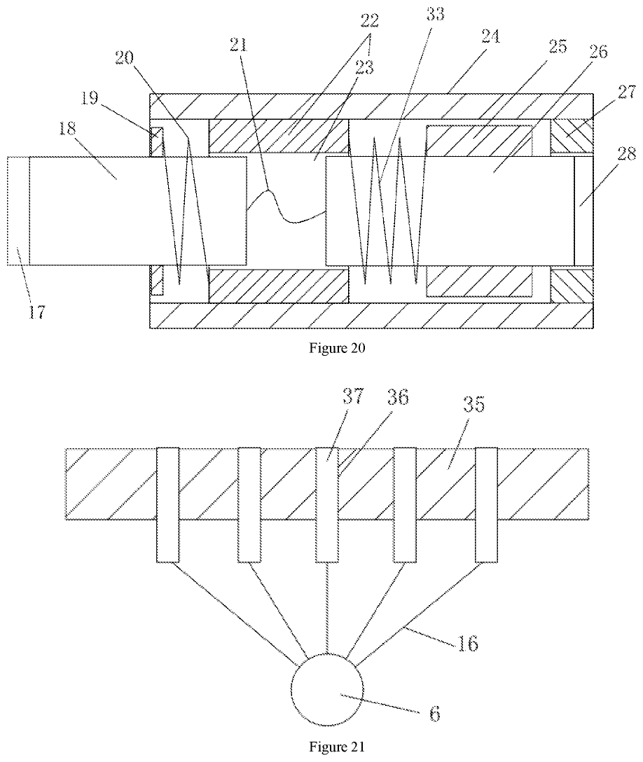

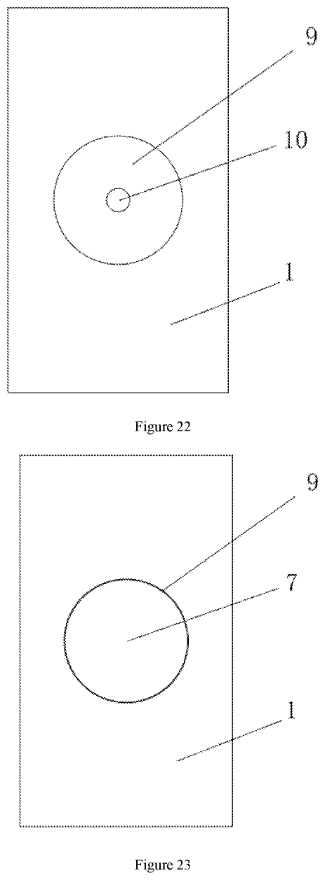

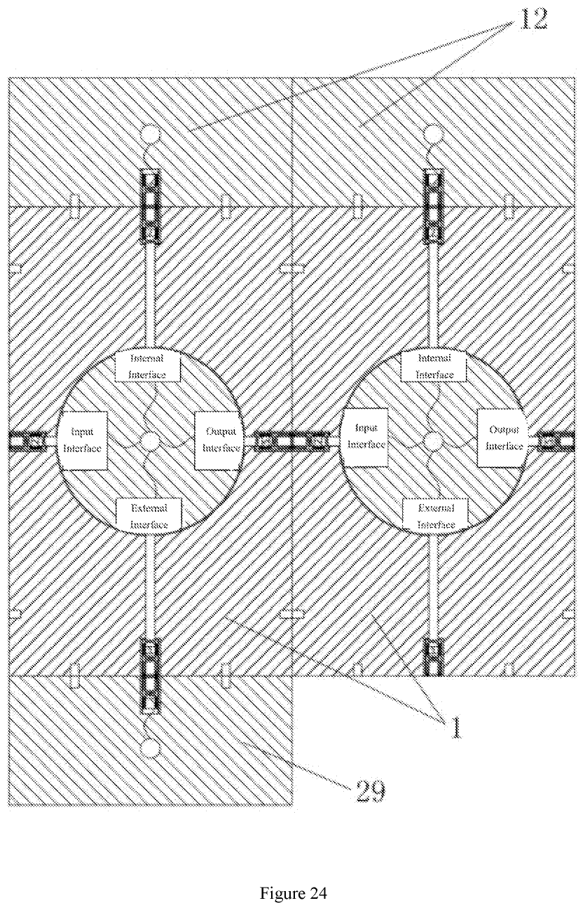

Embodiment 2, as shown in FIGS. 10-26, differs from Embodiment 1 in that: the instruction module is a tangible programming instruction building block that can realize instruction switching, as shown in FIGS. 10-26, comprising several basic building block groups and several storage building block groups; each basic building block group 31 comprises a plurality of mutually independent basic building blocks 1, and each storage building block group 30 comprises a plurality of mutually independent storage building blocks 12;

A basic module 6 is independently provided in each basic building block 1, and a main program is installed in each basic module independently. The two main programs installed in the two basic modules corresponding to any two basic building blocks in the same basic building block group are the same, and the two main programs installed in the two basic modules corresponding to any two basic building blocks that are not in the same basic building block group are different;

A storage module 15 is independently provided in each storage building block 12, and instructions are independently stored in each storage module. The two instructions stored in the two storage modules corresponding to any two storage building blocks in the same storage building block group are the same, and the two instructions stored in the two storage modules corresponding to any two storage building blocks that are not in the same storage building block group are different;

Display identifications 32 corresponding to the instructions stored in the storage module in the corresponding storage building block are screen-printed on the outer surface of each storage building block;

Four communication modules 4 respectively connected to the corresponding basic modules are respectively provided on each basic building block;

A communication module 13 connected to the corresponding storage module wire 14 is respectively provided on each storage building block;

The communication module on any storage building block can be connected to any communication module on any basic building block one-to-one, so that the corresponding basic module can be connected to the corresponding storage module; after any basic module is connected to a certain storage module, the main program in the basic module can read the instructions in the connected storage module and execute the read instructions.

The tangible programming instruction building block A comprises a replaceable storage building block and a replaceable basic building block, and a storage module and a communication module connected to the storage module are provided on the storage building block; the basic building block is provided with a basic module and four communication modules respectively connected to the basic module.

The tangible programming instruction building block B comprises a replaceable storage building block and a replaceable basic building block, and a storage module and a communication module connected to the storage module are provided on the storage building block; the basic building block is provided with a basic module and four communication modules respectively connected to the basic module.

The basic module of Embodiment 2 is a single-chip microcomputer. After the two communication modules are connected, the two communication modules use serial interfaces for serial communication.

In Embodiment 2, the hardware device carrying the main program is set in the basic building block, and the hardware device carrying the instruction is set in the storage building block. When in use, the basic building block where the basic module carrying the corresponding main program is located and the storage building block where the storage module bearing the corresponding instruction is located are connected together through the communication module to form a tangible programming building block containing the instruction and the main program. The instructions in the storage module will be read and run by the main program in the basic module, and the running results will be uploaded to the host module of the corresponding object, and then the host module will control the corresponding object through Bluetooth or WIFI to execute the instructions.

When the instructions to be run by the two objects are the same, the two objects can use the same storage block in staggered time periods; similarly, when the main programs to be run by the two objects are the same, the two objects can also use the same basic building block in staggered time periods; this Embodiment 2 solves the problem that in the mutually staggered time periods, when different objects need to perform the same running action, they can use the same storage block with the same instruction or the same basic block with the same main program. The more the same operation actions are performed between different objects, the more basic building blocks or storage building blocks can be saved, so that the cost of purchasing basic building blocks or purchasing storage building blocks is less, which is convenient for the promotion of tangible programming instruction building blocks.

For example, if both object A and object B can use instruction A, then object B can use instruction A when object A does not use instruction A; similarly, when object B does not use instruction A, object A can use instruction A; similarly, if both object A and object B can use main program A, then when object A does not use main program A, object B can use main program A; similarly, when object B does not use main program A, object A can use main program A.

In this way, the required number of basic modules in Embodiment 2 can be far less than the required number of basic modules in the prior art, and the required number of storage modules can also be far less than the number of storage modules required in the prior art. The reduction in the number of building blocks reduces costs and facilitates the popularization of tangible programming instruction building blocks.

This Embodiment 2 can realize tangible programming instruction building blocks for instruction switching; the tangible programming instruction building block is to set the hardware device carrying the main program and the hardware device carrying the instruction separately; when in use, the basic building block where the hardware device that needs to carry the corresponding main program is located and the storage building block where the hardware device that needs to carry the corresponding instruction is located can be detachably connected together to obtain a tangible programming instruction building block with switchable instructions; in the mutually staggered time periods, when different objects need to perform the same running action, they can use the same storage block with the same instruction or the same basic block with the same main program.

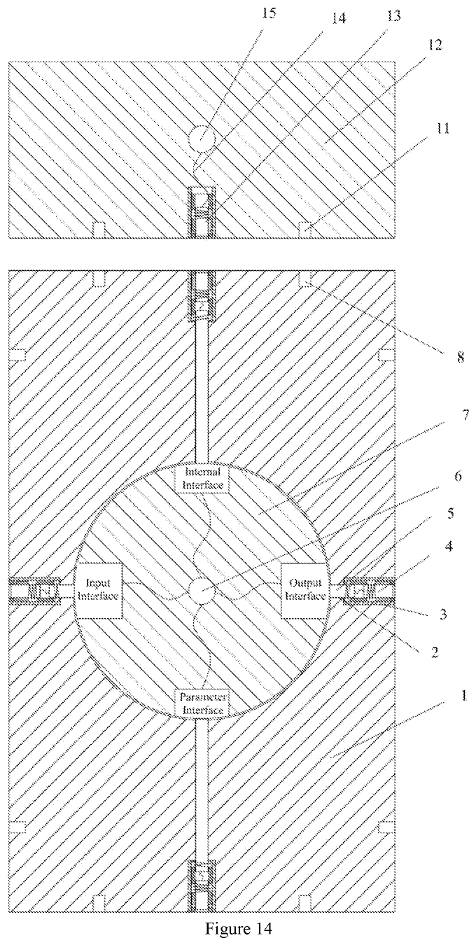

Embodiment 2: with reference to FIGS. 14-24, the basic module is the module that runs the main program; the communication module comprises a round tube 24, a wire protection tube 22, a tension spring 33, a magnet tube 25, an interface sliding tube 26, a serial interface 28, a magnetic conductive metal ring 27, and a wire 21; the length of the wire protection tube is less than the length of the round pipe; the outer wall of the wire protection tube is tightly sheathed and fixedly connected to the inner wall of the inner end of the round pipe; the outer wall of the magnetic conductive metal ring is tightly sleeved and fixedly connected to the inner tube wall at the outer port of the round tube; the magnet tube is slidably arranged in the round tube located between the wire protection tube and the magnetic conductive metal ring; the inner tube wall of the magnet tube is tightly sleeved and fixedly connected to the middle of the outer tube wall of the interface sliding tube, the inner end and outer wall of the interface sliding tube are slidably arranged at the outer end in the tube cavity 23 of the wire protection tube, and the outer end of the interface sliding tube and the outer tube wall are slidably arranged in the inner ring of the magnetic conductive metal ring; the two ends of the tension spring are respectively tightened and fixed on the outer surface of the wire protection tube and the inner surface of the magnet tube; the serial interface is arranged on the outer port of the interface sliding tube, and the serial interface is connected to the corresponding basic module or the corresponding storage module through a wire; the magnetic conductive metal ring is fixedly arranged in the basic building block on the side of the outer section hole, and the inner end surface of the magnetic conductive metal ring falls in the middle section hole, and the outer end surface of the magnetic conductive metal ring falls on the side surface of the basic building block.

In Embodiment 2, four side surfaces of each basic building block are respectively provided with communication modules connected to the corresponding basic modules; a communication module connected to the corresponding storage module is also provided on one side surface of each storage building block.

The tangible programming instruction building block further comprises an ejector rod; a cylindrical basic circular semi-through hole 9 is provided on the upper surface of the basic building block; the bottom surface of the basic circular semi-through hole is provided with an ejection through hole 10 that communicates with the lower surface of the basic building block; the diameter of the ejection through hole is larger than the diameter of the ejector rod;

The center of the four side surfaces of the basic building block are respectively provided with side wall grooves 3; the depth of the side wall groove is greater than or equal to the length of the circular tube; the four communication modules are respectively fixed in the side wall groove;

A straight hole 2 communicated with the basic circular semi-through hole is respectively provided on the groove bottom surface of each sidewall groove, and the four straight holes are respectively communicated with the corresponding basic circular semi-through hole;

An inner sliding tube 18 is slidably provided in the straight hole, and the outer tube wall of the outer end of the inner sliding tube is slidably provided in the inner end tube cavity of the wire protection tube of the communication module; a sleeve ring 19 is slidably provided in the circular pipe at the inner end of the wire production tube, and the inner ring of the sleeve ring is tightly connected to the outer pipe wall of the inner sliding pipe; both ends of a squeeze spring 20 are squeezed and fixed on the inner end surface of the wire production tube and the outer end surface of the inner ring respectively; a top-tight butt connection mechanism 17 is provided in the inner end nozzle of the inner sliding pipe; the top-tight butt connection mechanism on the inner sliding pipe is connected to the serial interface on the corresponding communication module through a wire;

A cylindrical block 7 is detachably inserted and fixed in the basic circular semi-through hole; the height of the cylindrical block is less than or equal to the depth of the basic circular semi-through hole, and the diameter of the cylindrical block is equal to the diameter of the basic circular semi-through hole;

The basic module 6 corresponding to the basic building block is provided in the cylindrical block; on the vertical side surface of the cylindrical block opposite to the pressing butt connection mechanism on the inner end surface of the inner sliding pipe, a pressing butt connection mechanism is also provided one-to-one respectively;

Each pressing butt connection mechanism on the cylindrical block is respectively connected to the corresponding basic module 6 through the wire 16; when the cylindrical block is detachably inserted and fixed in the basic circular semi-through hole, each pressing butt connection mechanism on the cylindrical block can be connected to the pressing butt connection mechanism on the inner end surface of the four inner sliding tubes by one-to-one pressing contact butt connection, so as to realize the information conduction between the corresponding basic module and the corresponding serial interface.

The top-tight butt connection mechanism comprises an insulating fixing plate 35 provided with a plurality of holes 36, and a conductive metal column 37 is respectively fixed in each hole on the insulating fixing plate; each conductive metal column on the insulating fixing plate of the pressing butt connection mechanism located on the inner end surface of the inner sliding tube is respectively connected to the corresponding basic module through a wire; each conductive metal column of the pressing butt connection mechanism located on the inner end surface of the inner sliding tube is respectively connected to the corresponding serial interface through a wire.

On the upper surface of the cylindrical block directly above each butt-joint connection mechanism on the cylindrical block, interface identifications are screen-printed one-by-one, respectively; the interface identification comprises an input interface identification, an output interface identification, an internal interface identification, and a parameter interface identification; the input interface identification and the output interface identification are arranged right and left facing each other, and the internal interface identification and the parameter interface identification are arranged facing up and down.

Solid-magnetic semi-through holes are respectively provided on the four vertical surfaces of the basic building block, and magnets 8 are respectively fixed in each of the solid-magnetic semi-through holes; on the outer surface of the storage building block, there are fixed block semi-through holes arranged opposite to the solid-magnetic semi-through holes on the base building block, and a magnetic metal block 11 is respectively fixed in each of the fixed block semi-through holes on the storage building block. On the outer surface of the parameter building block 29, there are also solid block semi-through holes arranged opposite to the solid-magnetic semi-through holes on the basic building block, and a magnetic metal block is also fixed in each of the semi-through holes of the solid block on the parameter building block.

The internal interface is the communication module connected between the basic module and the storage module; the parameter interface is the communication module connected between the basic module and the parameter module on the parameter building block;

The output interface on the basic building block is a communication module that outputs signals from the basic module on the basic building block; the input interface on the basic building block is a communication module that transmits signals from the basic module on other basic building blocks to the basic module on this basic building block.

Embodiment 2: the cylindrical block where the basic module is located is arranged to be connected to the basic circular semi-through hole detachably inserted into the structure. This structure includes at least three advantages: one is to facilitate the connection between the communication module on the storage building block and any communication module on the basic building block. After the communication module on the storage building block is connected to one of the communication modules on the base building block, the basic module is connected to the storage module by adjusting the corresponding internal interface on the cylindrical block. Thus, the positions of the output interface, input interface and parameter interface on the basic building block are determined, which is convenient for users to use. Second, when the basic module is broken, only the cylindrical block part needs to be replaced, and the entire basic building block does not need to be replaced, which reduces the cost. Third, any two basic building blocks can be exchanged with each other to use the cylindrical block part, which has good reliability.

When the two communication modules are connected to each other, the magnetic permeability of the magnetic conductive metal ring will attract the two magnet tubes to the outside, therefore, the magnet tube drives the corresponding interface sliding tube to move outward, so that the two serial interfaces are connected together to realize serial communication connection.

When the cylindrical block is inserted into the basic circular semi-through hole, the corresponding conductive metal column on the cylindrical block and the conductive metal column on the inner sliding tube are connected in a butt-conducting manner, so that the line between the storage module and the basic module is connected, and it is convenient for the basic module to read the instructions on the storage module.

This arrangement of Embodiment 2 greatly improves the flexibility and reliability of the basic building block.

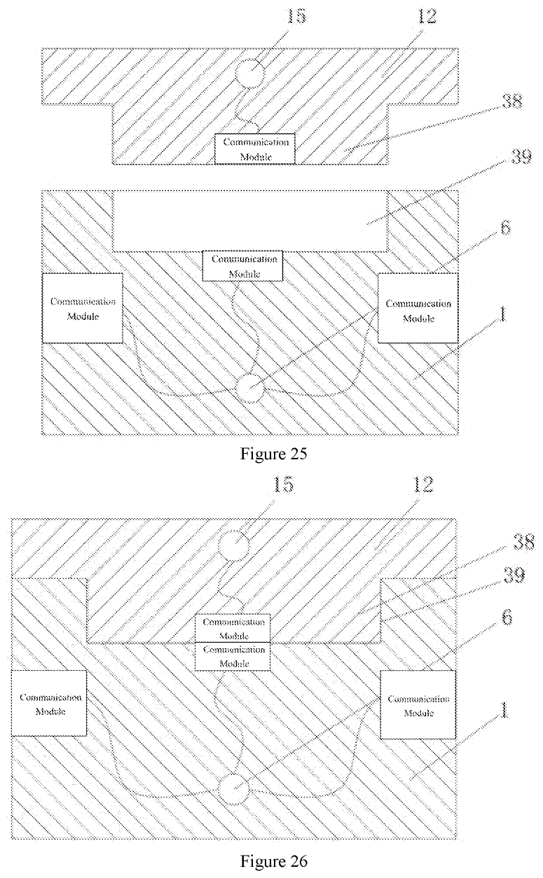

Embodiment 3: with reference to FIG. 25-26, an upper surface groove 39 is provided in the middle of the upper surface of the basic building block 1, and a positioning protrusion 38 matching the upper surface groove is provided in the middle of the lower surface of the storage building block 12; one of the communication modules in the several communication modules located on the same basic building block is provided in the middle of the upper table groove on the basic building block; the communication module located on the storage building block is arranged in the middle of the positioning protrusion on the corresponding storage building block; any storage building block can be fastened and connected one-to-one in the upper surface groove of any basic building block through its own positioning protrusion to realize the detachable fixed connection between the storage building block and the corresponding basic building block, and when the positioning protrusions on the storage building blocks are clamped and fixedly connected to upper surface groove of the basic building blocks, the communication modules on the storage building blocks are butt-connected to the communication modules on the corresponding basic building blocks.

On the three side surfaces of each basic building block and the upper surface of each basic building block are respectively provided with communication modules connected to the corresponding basic modules; communication modules connected to the corresponding storage modules are also provided on the lower surface of each storage building block. The communication modules are all in serial communication.

In this embodiment, the basic building block and the storage building block are connected together to form a tangible programming building block, which can also realize the reuse of basic modules that execute the same program. At the same time, it is also possible to realize the reuse of memory modules that execute the same instruction. Multiple running actions for multiple objects can be obtained with fewer storage modules and fewer base modules.

The embodiments of the invention are described hereinabove with reference to the drawings, but implementation is not limited by the above embodiments. Those of ordinary skill in the art can make various changes or modifications within the scope of the appended claims.

1. An intelligent building block-based Chinese character learning system, comprising:
An instruction module, which is used for bearing Chinese characters and building block assembly of the Chinese characters;
A master control board module, which is used for reading the Chinese characters assembled by the instruction module, displaying the assembled Chinese characters, and synchronizing the assembled Chinese characters to a mobile phone or an iPad;
An online course module, which is used for reading the Chinese characters synchronized by the master control board module and searching for an online course, recognizing the three elements of “shape, sound and meaning” and the development history of the Chinese character through the guidance of the online course, and expanding to the historical stories related to the Chinese character.

2. The intelligent building block-based Chinese character learning system of claim 1, wherein:
(2.1) The building blocks of Chinese characters communicate with each other through serial communication, and the Chinese character instructions and the topological relationship between the instructions stored in the EEPROM are sent to the master control board;
(2.2) After the master control board reads the Chinese character instructions and the topological structure, it calculates according to the Chinese character recognition process to form a complete Chinese character, and displays the Chinese character on an ink screen;
(2.3) The master control board synchronizes the instructions and the topological structure to the iPad through Bluetooth, and the iPad also analyzes it, displays the Chinese character, and looks up the ancient Chinese dictionary and corresponding online courses; if the Chinese character does not exist, the user will be prompted that such a combination does not exist; if the corresponding online course is found, the course will be played; if no online course is found, the explanation in the ancient Chinese dictionary will be played.

3. The intelligent building block-based Chinese character learning system of claim 2, wherein:
In step (2.1), the building blocks communicate with the outside world through the serial port, and read Chinese character instructions from top to bottom or left to right; CRC check is performed on externally read commands; read the local Chinese character instruction stored in the EEPROM; combine the topological structure of the external Chinese character instruction with the local Chinese character instruction; send the combined instruction up and left;
In step (2.2), the Chinese character recognition process is as follows:
First, the master control board will select the commonly used single characters and create a single character table;
Each building block represents a single character, and a single character instruction library is created with unicode as the hash value, and the unicode of the Chinese character is stored in the EEPROM of the building block;
The master control board will select the commonly used radicals and create a radical table;
The radicals are divided into left and right, up and down and semi-enclosed structures according to the size;
A database of commonly used Chinese characters is created based on the method of splitting Chinese characters;
According to the order from top to bottom and from left to right, one thousand commonly used Chinese characters are split into radicals and single characters, and a database composed of unicode is created;
The master control board finds Chinese characters by reading the building block instructions and the topological relationship between them through the serial port;
The master control board displays the Chinese character through the ink screen;
If it is a Chinese character phrase, topological analysis is performed in the same way, but ambiguity may occur; at this time, it is necessary to look up the corresponding dictionary according to the Chinese characters to display the possible Chinese character phrase.
